(19) United States
(12) Patent Application Publication
(10) Pub. No.: US 2015/0277049 A1
(43) Pub. Date: Oct. 1, 2015

(54) OPTICAL DELAY LINE FORMED AS SURFACE NANOSCALE AXIAL PHOTONIC DEVICE

(71) Applicant: OFS Fitel, LLC, Norcross, GA (US)

(72) Inventor: Mikhail Sumetsky, Bridgewater, NJ (US)

(73) Assignee: OFS Fitel, LLC, Norcross, GA (US)

(21) Appl. No.: 14/267,058

(22) Filed: May 1, 2014

Related U.S. Application Data
(60) Provisional application No. 61/819,523, filed on May 3, 2013.

(51) Int. Cl. G02B 6/26; G02B 6/02

(52) U.S. Cl. CPC G02B 6/26; G02B 6/0229; G02B 6/02295; B82Y 20/00

(57) ABSTRACT

A surface nanoscale axial photonic (SNAP) device in the form of an optical bottle resonator is configured to exhibit a semi-parabolic profile (in terms of a change in radius along the longitudinal direction of the fiber). It has been found that this semi-parabolic profile provides the ability to create the dispersionless delay of optical pulses, where “dispersionless” in this case is considered to mean that the pulse retains its same shape with minimal distortions as it passes back and forth within the bottle resonator (i.e., minimal pulse-broadening). Delays on the order of several nanoseconds have been created within these semi-parabolic-shaped SNAP bottle resonators of about 3 mm in length (as compared with prior art microresonator devices' ability to create delays no greater that 1 ns, at best).

### CROSS-REFERENCE TO RELATED APPLICATIONS

This application claims the benefit of U.S. Provisional Application Ser. No. 61/819,523, filed May 3, 2013 and herein incorporated by reference.

### TECHNICAL FIELD

This application relates to an optical delay line that is formed as a surface nanoscale axial photonic (SNAP) device and, more particularly, to a micro-sized optical delay line that is capable of providing relatively long pulse delays while minimizing the effects of dispersion on the pulse.

### BACKGROUND OF THE INVENTION

Significant progress has been achieved in the fabrication of miniature optical resonance delay lines, which have been proposed as one of the basic elements of future computer and communication systems. In most cases, these miniature delay lines take the form of periodic photonic crystal structures or coupled microresonator structures (i.e., planar photonic devices). However, factors such as attenuation of light and insufficient fabrication precision have remained as impediments to progress in this area.

Recently, a variety of devices and structures based upon a new technological platform for the fabrication of photonic circuits defined as “surface nanoscale axial photonics” (SNAP) has been developed that is capable of addressing these concerns. In particular, SNAP devices can be thought of as microscopic optical devices that are created by smooth and dramatically small nanoscale variations of an optical fiber's radius and/or its refractive index (collectively defined as the optical fiber's “effective radius”). An optical signal is introduced into this optical fiber structure in a manner where the light circulates transversely around the perimeter of the fiber (i.e., as whispering gallery modes) while also experiencing slow propagation along the direction of the fiber's longitudinal axis. The slowly-propagating signal will move between “turning points” defined in a manner that allows for a delay of a predetermined duration (on the order of nanoseconds) to be introduced into an input optical pulse signal.

### SUMMARY OF THE INVENTION

The present invention is directed to an optical delay line that is formed as a surface nanoscale axial photonic (SNAP) device and, more particularly, to a micro-sized optical delay line that is capable of providing relatively long pulse delays while minimizing the effects of dispersion on the pulse.

In accordance with an exemplary embodiment of the present invention, a SNAP device in the form of an optical bottle resonator having a semi-parabolic profile (in the longitudinal direction of the fiber) is created to provide dispersionless delay of optical pulses, where “dispersionless” in this case is considered to mean that the pulse retains its same shape with minimal distortions as it passes back and forth within the bottle resonator (i.e., minimal pulse-broadening). Delays on the order of several nanoseconds have been created within SNAP bottle resonators of about 3 mm in length (as compared with prior art microresonator devices' ability to create delays no greater that 1 ns, at best).

The inventive SNAP resonator may also be configured to be “impedance matched” to the optical input/output signal path (e.g., microfiber, waveguide or other light-guiding structure) by controlling the orientation of the optical input/output signal path with respect to the SNAP resonator such that essentially all of the optical input signal is coupled into the SNAP device.

In one embodiment, the present invention comprises an optical delay line comprising a segment of optical fiber and having a nominal radius r₀ and nominal refractive index value n_{f0}, the segment of optical fiber configured to include a surface nanoscale axial photonic (SNAP) bottle resonator formed along a longitudinal portion thereof (where the SNAP bottle resonator exhibits a predetermined change in effective radius between a pair of turning points defining an axial length of the SNAP bottle resonator) and an input/output waveguide (e.g., optical microfiber) for supporting the propagation of an optical pulse signal. The input/output waveguide is disposed adjacent to the segment of optical fiber in a manner that couples the optical pulse signal into the SNAP bottle resonator, with the SNAP bottle resonator imparting a delay of a predetermined length to the optical pulse signal prior to coupling the optical pulse signal back into the input/output waveguide.

Other and further aspects of the present invention will become apparent during the course of the following discussion and by reference to the accompanying drawings.

### BRIEF DESCRIPTION OF THE DRAWINGS

Referring now to the drawings, where like numerals represent like parts in several views,

FIG. 1 is a diagram illustrating the principles of surface nanoscale axial photonic (SNAP) devices;

FIG. 2 illustrates an exemplary SNAP optical bottle resonator for use as an optical delay line in accordance with the present invention;

FIG. 3 is a diagram illustrating the change in potential energy along the length of the bottle resonator of FIG. 2;

FIG. 4 includes plots of group delay and transmission amplitude of the circulating optical signal slowly propagating along the longitudinal axis of the SNAP optical bottle resonator of FIG. 2, with FIGS. 4(a) and (b) containing the group delay and transmission amplitude plots associated with a first contact point z₁ (the “contact point” defining the location where an input/output waveguide is positioned along the resonator) and FIGS. 4(c) and (d) containing the group delay and transmission amplitude plots associated with a second contact point z₂; and

FIG. 5 contains plots of pulse propagating along the SNAP optical bottle resonator of FIG. 2, with the pulse propagation in FIG. 5(a) associated with first contact point z₁ and the pulse propagation shown in FIG. 4(b) associated with second contact point z₂.

### DETAILED DESCRIPTION

By way of introduction to the subject matter of the present invention as described hereinbelow in association with FIGS. 2-5, FIG. 1 illustrates an exemplary arrangement that is utilized to create WGMs in a tapered section of optical fiber, as more fully described in our previous work as embodied in U.S. application Ser. No. 13/396,780, filed Feb. 15, 2012 and entitled “Fiber-Based Photonic Microdevices with Sub-Wavelength Scale Variations in Fiber Radius”, herein incorporated by reference.

As shown, a section of optical fiber 1 (defined as a “device fiber”) is formed to include a tapered region 2, where the tapering is formed on a nanometer scale. That is, the radius of device fiber 1 is caused to vary on a nanometer scale as a function of the length of the fiber (i.e., along the z-axis of the fiber as shown in FIG. 1). It is to be understood that the modification of the fiber radius may include a physical change in the actual radius of the fiber, a local modification in the refractive index of the fiber, or both a physical radius change and a refractive index change—all referred to in this application as changes in the “effective radius” of an optical fiber.

Continuing with the description of FIG. 1, an optical microfiber 3 supplies an input optical signal to device fiber 1. In general, a “microfiber” is defined as an optical fiber having a diameter on the order of about 0.1 to 10 times the propagating wavelength; for a 1.5 μm signal, this translates to a diameter on the order of 0.15-15 μm. It is to be understood that any suitable type of optical waveguiding device that creates evanescent coupling may be used to provide an input signal to device fiber 1, with the present discussion using the term “microfiber” for convenience only. Referring to FIG. 1, optical microfiber 3 is positioned close enough to device fiber 1 so that evanescent coupling occurs and at least a portion of the optical signal propagating along microfiber 3 transfers to device fiber 1.

A light source 4 is shown as used to introduce an optical signal O into microfiber 3. As optical signal O propagates along microfiber 3, a portion will evanescently couple into tapered region 2 of device fiber 10 and create WGMs in device fiber 1 within the vicinity of the overlap between device fiber 1 and microfiber 3, as shown in FIG. 1. As shown, the WGMs spiral around the periphery of surface S of device fiber 1 while they slowly “propagate” along longitudinal axis z of device fiber 1. Optical signal O continues to propagate along microfiber 3 and is ultimately coupled into a detector 5, which measures the characteristics of the received signal to monitor the resonant behavior within device fiber 1. For the arrangement of FIG. 1, it can be shown that a resonance associated with the WGMs will be fully confined between a turning point, zₜ, and the point where microfiber 3 couples to (i.e., “contacts”) device fiber 10 (shown as point z₁ in FIG. 1).

The phenomena as described above has now opened up research into more complex devices, based on the ability to create WGMs within sections of optical fiber having these types of effective radius variations. In particular, surface nanoscale axial photonics (SNAP) is an emerging area of study regarding microscopic optical devices that are created by smooth and dramatically small nanoscale variations of the optical fiber's radius and/or its refractive index (i.e., “effective radius variation”). In particular, the present invention describes a bottle resonator formed as a SNAP device that is capable of providing delays on the order of several nanoseconds, while introducing minimal distortion to the pulse shape of the coupled optical signal (i.e., “dispersionless”).

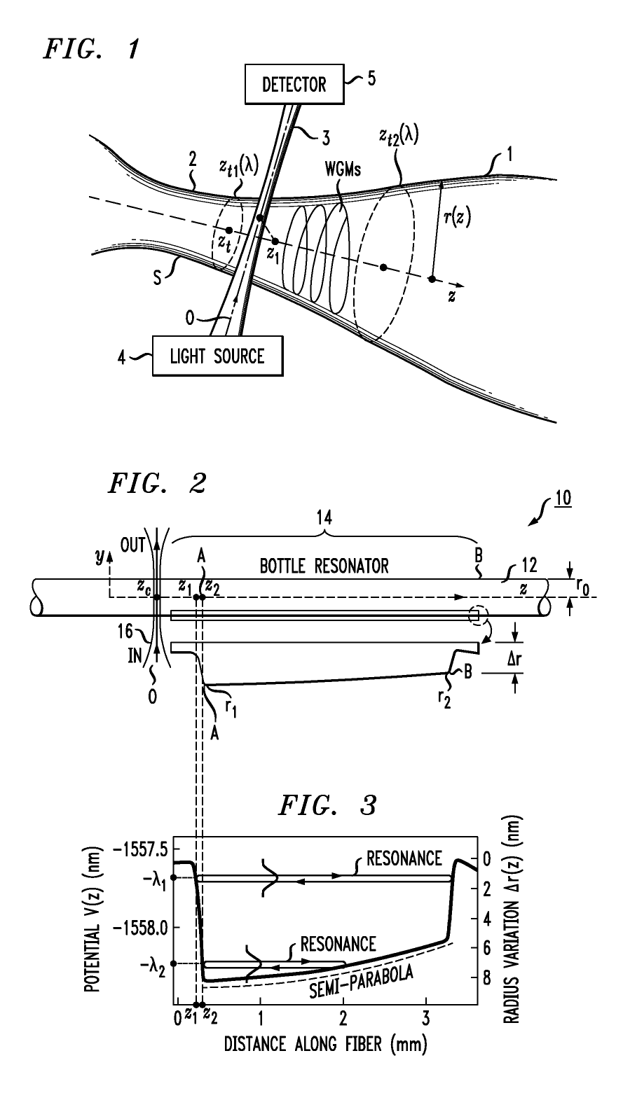

FIG. 2 illustrates an exemplary surface nanoscale axial photonic (SNAP) bottle resonator 10, formed in accordance with the present invention. As shown, SNAP bottle resonator 10 comprises an optical fiber 12 (referred to hereinafter as “device fiber 12”). The resonating structure is formed in this case by modifying the radius of device fiber 12 along a selected section 14 (the change in radius best shown in the enlarged portion of FIG. 2). In particular and in accordance with the present invention, the radius of fiber section 14 is modified (either physically or via changes in refractive index, or both) to exhibit a semi-parabolic form. As shown in FIG. 2, the modification in radius along fiber section 14 follows a semi-parabolic path from a first point A having a radius of r1 (greatest value) to a second point B having a radius of r2 (least value). The advantages of this semi-parabolic contour will be described hereinbelow.

Returning to the description of FIG. 2, an optical microfiber 16 is shown as disposed adjacent to SNAP bottle resonator 10 in a manner that couples an optical signal O propagating along microfiber 16 into SNAP bottle resonator 10; that is, optical microfiber 16 is utilized as the optical input/output waveguide of the arrangement. As described in our prior related to SNAP devices and shown in FIG. 1, the optical signal coupled into bottle resonator 10 from microfiber 16 will circulate as WGMs around the circumference of device fiber 12, while also slowly propagating along the longitudinal extent (i.e., along the z-axis) of device fiber 12.

The slow propagation of the WGMs along the longitudinal axis z of device fiber 12 can be described by a one-dimensional Schrödinger equation, with the potential energy of the propagating signal, denoted V(z), being proportional to the nanoscale variation of effective fiber radius Δr(z); in particular V(z)˜−Δr(z). It is assumed that the radius variation Δr(z) follows a semi-parabolic contour to form a bottle resonator that contacts microfiber 16 at point z_{c} and traps light between turning points zₜ₁(λ) and zₜ₂(λ).

FIG. 3 illustrates the potential energy diagram for SNAP bottle resonator 10 of FIG. 2. Since the bottle resonator is formed to exhibit a semi-parabolic form, the potential energy will take on a quantum well form, as shown in the diagram of FIG. 3. The contour of a parabolic curve is shown as a dotted line in FIG. 3, showing that the radial variation of bottle resonator 10 matches this contour to within a factor of less than a 1 nm, more than sufficient to create a bottle resonator with the desired dispersionless, large delay attributes that are desirable in a micron-scaled optical device.

Large delays (on the order of several nanoseconds, for example) within a finite bandwidth are achieved in a SNAP bottle resonator formed in accordance with the present invention when there is a relatively large separation between the turning points of the resonator structure and, therefore, for large phase values φ(λ,zₜ₁,zₜ₂)>>1. As described in detail below in a section entitled “Theory of Impedance-Matched Dispersionless Bottle Resonator”, these requirements of large separation and large phase value causes corruption of the delay line performance, due to strong and rapid oscillations of the transmission amplitude and group delay as a function of wavelength.

It has been found that these oscillations vanish at contact point z₀ in the vicinity of wavelength λ₀ for microfiber/resonator coupling parameters determined from the developed theory as described in detail below. To avoid dispersion (that is, changes in the shape of the input pulse propagating back and forth within the resonator structure), the eigenfrequencies are required to be locally equidistant. This constraint is satisfied by having Δr(z) follow the semi-parabolic shape.

Numerical simulations have shown that if the coupling parameters between resonator 10 and microfiber 16 are optimized and the eigenfrequencies of the resonator are sufficiently equidistant and dense, then resonator 10 can be impedance-matched to microfiber 16 and create a multi-nanosecond delay at the desired telecommunication wavelengths within a nanometer bandwidth. Indeed, this is accomplished within a nanometer bandwidth having negligible dispersion and minimal losses. One approach to optimizing the coupling parameters is to translate microfiber 16 along both its y axis (as shown in FIG. 2) and the z axis of device fiber 12 until maximum coupling is achieved. The arrangement is thus considered to be “impedance matched” for the purposes of the present invention when a configuration providing maximum coupling is obtained.

In one exemplary embodiment of the present invention, a SNAP bottle resonator as shown in FIG. 2 was designed to provide dispersionless and impedance-matched propagation of 100 ps pulses. A device fiber 12 having a nominal radius r₀ of 19 μm was used, with a focused CO₂ laser beam used to introduce the semi-parabolic variation in radius as required to form the bottle resonator. The resonator was formed to have a length of about 3 mm, and the depth of Δr(z) was measured to be about 8 nm. The parabolic portion of Δr(z) with equidistant eigenfrequencies was introduced to ensure the dispersionless propagation of the 100 ps pulses with the slowest-possible speed near the bottom of quantum well V(z) (as shown in FIG. 3).

For this particular configuration, two sets of wavelengths and contact points (λ₁, z₁) and (λ₂, z₂) were found to satisfy the “dispersionless” and “impedance-matched” criteria—exhibiting suppressed oscillations of group delay and transmission amplitude spectra for the same coupling parameters (i.e., the same displacement of microfiber 16 along its y axis). Indeed, these two points z₁,z₂ were found to be in excellent agreement with the values associated with the developed theory (and shown in FIGS. 2 and 3).

Referring to FIGS. 2 and 3, the vicinity of wavelength λ₁ at contact point z₁ of SNAP bottle resonator 10 (see FIG. 2) corresponds to the propagation of light near the top of quantum well V(z) as shown in FIG. 3. At contact point z₂, the vicinity of wavelength λ₂ corresponds to the area of slowest propagation in the parabolic part of quantum well V(4, and thus provides the largest amount of delay for a propagating pulse. As shown in FIG. 3, the eigenfrequency near the bottom of quantum well V(z) is associated with contact point z₂.

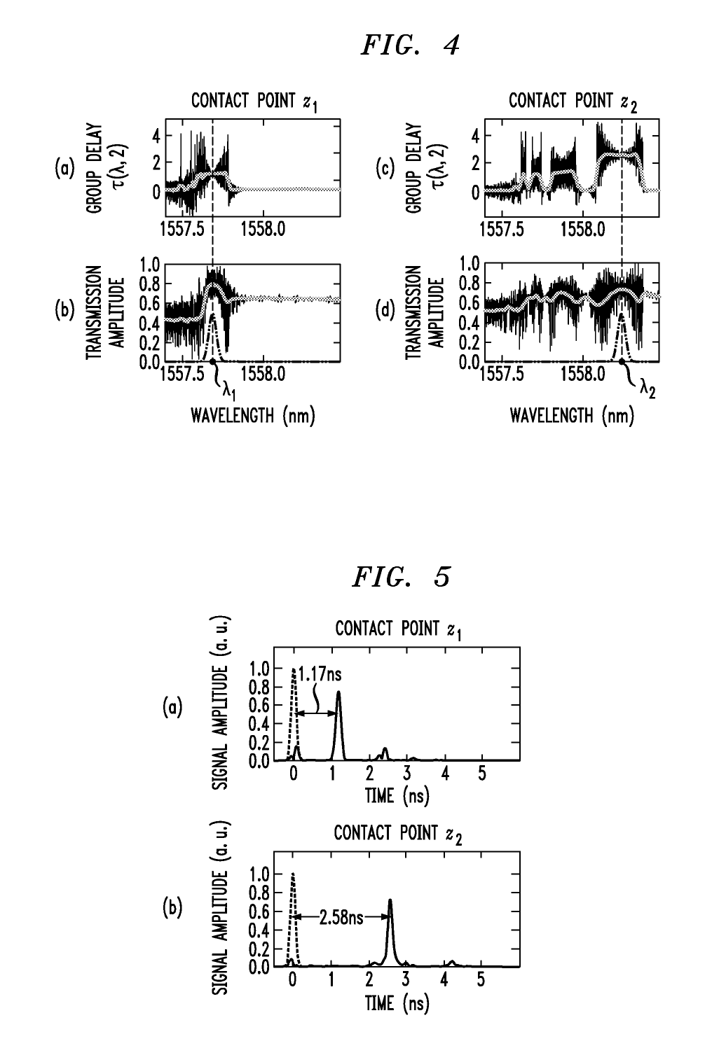

FIG. 4 contains plots of experimentally-measured group delay τ(λ,z) and transmission amplitude spectrum for these same two contact points z₁ and z₂, with FIGS. 4(a) and (b) being plots of these two parameters associated with contact point z₁. In particular, FIG. 4(a) illustrates the group delay (defined as τ and measured in nanoseconds) as a function of wavelength in the vicinity of λ₁. The transmission amplitude (as well as a 100 ps Gaussian input pulse at λ₁) is shown in FIG. 4(b), in this case shown in arbitrary units normalized to unity. FIGS. 4(c) and (d) are the plots associated with group delay and transmission amplitude, respectively, at contact point z₂.

FIGS. 5(a) and (b) show the time-dependent propagation of a 100 ps Gaussian pulse calculated from the spectra shown in FIG. 4. The average group delays in FIGS. 4(a) and (c) are shown to be in excellent agreement with the delay times 1.17 ns and 2.58 ns shown in FIGS. 5(a) and (b). The longer delay associated with contact point z₂ thus confirms that the longest delay is found in the lower region of the parabolic part of potential V(z), as shown in FIG. 3. A comparison of the average transmission amplitudes in FIGS. 4(b) and (d) with the corresponding delay times determines the intrinsic loss of the SNAP bottle resonator to be on the order of 0.44 dB/ns. In contrast, prior art microresonators used as delay elements exhibit intrinsic losses in the range of 10-100 dB/ns.

### Theory of Impedance-Matched Dispersionless Bottle Resonator

Modes in an optical fiber are characterized by the propagation constant β(λ,z), which is a function of both the radiation wavelength λ and variations of both the fiber radius r(z)=r₀+Δr(z) and its refractive index n_{f}(z)=n_{f0}+Δn_{f}(z). In conventional optical fibers, light is directed along the interior fiber core and exhibits a propagation constant close to β₀(λ)=2πn_{fo}/λ. In contrast, SNAP employs transverse WGMs wrapped around the fiber surface by total internal reflection. The propagation constant of these modes is much smaller than β₀(λ) and the speed of their axial propagation (i.e., the conventional propagation along the longitudinal axis of the optical fiber) is much smaller than the speed of light in the fiber material, c/n_{f0}. In fact, the axial speed of a WGM and its propagation constant can be zero at the resonance wavelength λᵣₑₛ, defined by the condition of “stopped axial propagation”, namely β(λᵣₑₛ+iγᵣₑₛ,Z)=0, where the resonance width γᵣₑₛ determines the propagation loss.

A central premise of SNAP devices is to exploit the sensitivity of WGMs to extremely small variations of the fiber radius and refractive index near the resonance wavelength γᵣₑₛ. Generally, a variation in radius causes coupling between modes and intermodal transitions, a complex problem that generally needs to be addressed by a system of coupled wave equations. Advantageously, for SNAP devices this problem is absent; the variations in Δr(z) and Δn_{f}(z) are so small and smooth that the coupled wave equations become decoupled, and a single WGM can be analyzed and is defined by a single differential equation. That is, the slow axial propagation of light in SNAP devices can be described by the one-dimensional wave equation:

Ψ_{zz}+β²(λ,z)=0,

with propagation constant β(λ,z) defined as follows:

β(λ,z)=(E(λ)−V(z))^{1/2}, where

E(λ)=(2^{3/2}πn/λᵣₑₛ)²(Δλ/λᵣₑₛ),

V(Z)=−(2^{3/2}πn/λᵣₑₛ)²(Δr/r₀),

and Δλ=λ−λᵣₑₛ is the wavelength variation near a resonance λᵣₑₛ and n is the refractive index of the fiber.

In accordance with the principles of the present invention, it is presumed that the radius variation Δr(z) takes the form of a bottle resonator (i.e., V(z) is a quantum well), which contacts microfiber 16 at point z_{c} (see FIG. 2) and traps light between turning points zₜ₁(λ) and zₜ₂(λ).

In the semi-classical approximation, the group delay τ(λ,z) is defined as follows:

$$τ ( λ , z ) = ( \frac{{λ}^{2} n}{2 π c} ) Im ( \partial ln ( S ( λ , z ) ) / \partial λ ) ,$$

where the transmission amplitude S(λ,z) at contact point z=z_{c} is defined as follows:

$$S ( λ , {z}_{c} ) = {S}_{0} - \frac{i {\vert C \vert}^{2} G ( λ , {z}_{c} , {z}_{c} )}{1 + DG ( λ , {z}_{c} , {z}_{c} )} , where$$

$$G ( λ , z , z ) = \frac{cos ( ϕ ( λ , {z}_{t 1} , z ) + \frac{π}{4} ) cos ( ϕ ( λ , z , {z}_{t 2} ) + \frac{π}{4} )}{i β ( λ , {z}_{1} ) cos ( ϕ ( λ , {z}_{t 1} , {z}_{t 2} ) )} and$$

$$ϕ ( λ , {z}_{1} , z ) = {\int }_{{z}_{1}}^{z} β ( λ , z ) d z .$$

The initial transmission amplitude value S₀ is defined as the out-of-resonance amplitude, and the quantities C and D are the bottle resonator/microfiber coupling constants, and G(λ,z₁,z₂) is the Green's function of the wave equation.

Large delays within a finite bandwidth are achieved only for a large separation between turning points zₜ₁, zₜ₂, and, therefore for large phase φ(λ,zₜ₁,zₜ₂)>>1. When considering this value of φ with the above equations, it is shown that this causes corruption of the delay line performance due to strong and rapid oscillations of the transmission amplitude and group delay as a function of wavelength. However, it has been found that the oscillations vanish in the vicinity of wavelength λ₀ at microfiber position z₀ under the following conditions:

$$Im ( {S}_{0} ) = 0 , \\ {\vert C \vert}^{2} = 2 {S}_{0} Im ( D ) , \\ β ( {λ}_{0} , z ) = Im ( D ) , and$$

$$\frac{Im ( D )}{Re ( D )} = tan ( ϕ ( {λ}_{0} , {z}_{t 1} , {z}_{t 2} ) + \frac{π}{4} ) .$$

### ****

While described above in terms of forming a “dispersionless” device (e.g., less than 2% pulse broadening in experimental systems), there may be instances where it is desired to introduce a controlled amount of dispersion into the SNAP bottle resonator, in particular for dispersion compensation applications. In this case of dispersion compensation, a SNAP bottle resonator of the present invention can be configured to exhibit a non-uniform distribution of eigenfrequencies, such as by modifying the semi-parabolic contour of the bottle resonator. The specific amount of non-uniformity is determined in association with the amount of dispersion compensation that is required for the intended application.

Indeed, while specific examples of the invention are described in detail above to facilitate explanation of various aspects of the invention, it should be understood that the intention is not to limit the invention to the specifics of the examples. Rather, the intention is to cover all modifications, embodiments and alternatives falling within the spirit and scope of the invention as defined by the appended claims.

What is claimed is:

1. An optical delay line comprising:
a segment of optical fiber having a nominal radius r₀ and a nominal refractive index value n_{f0}, the segment of optical fiber configured to include a surface nanoscale axial photonic (SNAP) bottle resonator formed along a longitudinal portion thereof, where the SNAP bottle resonator exhibits a predetermined change in effective radius between a pair of turning points defining an axial length of the SNAP bottle resonator; and
an input/output waveguide for supporting the propagation of an optical pulse signal, the input/output waveguide disposed adjacent to the segment of optical fiber in a manner that couples the optical pulse signal into the SNAP bottle resonator such that the SNAP bottle resonator imparts a delay of a predetermined length to the optical pulse signal prior to coupling the optical pulse signal back into the input/output waveguide.

2. An optical delay line as defined in claim 1 wherein the predetermined change in effective radius is achieved by introducing a physical change in the nominal radius r₀ along a longitudinal z-axis, Δr(z)=r(z)−r₀.

3. An optical delay line as defined in claim 1 wherein the predetermined change in effective radius is achieved by introducing a change in the nominal refractive index value n_{f0} along a longitudinal z-axis, Δn_{f}(z)=n_{f}(z)−n_{f0}.

4. An optical delay line as defined in claim 1 wherein the predetermined change in effective radius is achieved by introducing changes in both the nominal radius and the nominal refractive index of the optical fiber segment.

5. An optical delay line as defined in claim 1 wherein the input/output waveguide is oriented with respect to the segment of optical fiber in a manner that controls the coupling efficiency of the propagating optical pulse signal between the input/output waveguide and the SNAP bottle resonator.

6. An optical delay line as defined in claim 5 wherein the input/output waveguide comprises an optical microfiber.

7. An optical delay line as defined in claim 6 wherein the optical microfiber is oriented with its longitudinal axis orthogonal to the longitudinal axis of the segment of optical fiber, with the optical microfiber translated along both axes until a predetermined coupling efficiency is achieved.

8. An optical delay line as defined in claim 1 wherein the SNAP bottle resonator is configured as a dispersionless SNAP bottle resonator exhibiting a semi-parabolic change in effective radius between the pair of turning points such that the eigenfrequencies of the bottle resonator are locally equidistant.

9. An optical delay line as defined in claim 1 wherein the SNAP bottle resonator is configured as a dispersion-compensated SNAP bottle resonator having a non-uniform spacing between adjacent eigenfrequencies, wherein the effective radius of the SNAP bottle resonator is controlled to introduce a predetermined amount of dispersion into the optical pulse signal propagating therealong.

10. A fiber-based optical bottle resonator formed along a segment of optical fiber having a nominal radius r₀ and nominal refractive index value n_{f0}, the fiber-based optical bottle resonator being a surface nanoscale axial photonic (SNAP) device which exhibits a predetermined change in effective radius between a pair of turning points defining an axial length of the SNAP bottle resonator, the predetermined change in effective radius corresponding to a predetermined optical signal delay created by the optical bottle resonator.

11. A fiber-based optical bottle resonator as defined in claim 10 wherein the predetermined change in effective radius is achieved by introducing a physical change in the nominal radius r₀ along a longitudinal z-axis of the optical fiber, Δr(z)=r(z)−r₀.

12. A fiber-based optical resonator as defined in claim 10 wherein the predetermined change in effective radius is achieved by introducing a change in the nominal refractive index value n_{f0} along a longitudinal z-axis, Δn_{f}(z)=n_{f}(z)−n_{f0}.

13. A fiber-based optical resonator as defined in claim 10 wherein the predetermined change in effective radius is achieved by introducing changes in both the nominal radius and nominal refractive index of the optical fiber.

14. A fiber-based optical resonator as defined in claim 10 wherein the fiber-based optical resonator is configured as a dispersionless SNAP bottle resonator exhibiting a semi-parabolic change in effective radius between the pair of turning points such that the eigenfrequencies of the bottle resonator are locally equidistant.

15. A fiber-based optical resonator as defined in claim 10 wherein the fiber-based optical resonator is configured as a dispersion-compensated SNAP bottle resonator having a non-uniform spacing between adjacent eigenfrequencies, wherein the effective radius of the SNAP bottle resonator is controlled to introduce a predetermined amount of dispersion into the optical pulse signal propagating therealong.
